(19) United States
(12) Patent Application Publication
(10) Pub. No.: US 2011/0079249 A1
(43) Pub. Date: Apr. 7, 2011

(54) BEVERAGE DISPENSER

(75) Inventors: Daryl G. Erbs, Sheboygan, WI (US); James R. Mosenfelder, Appleton, WI (US); Jerry L. Landers, Memphis, IN (US); Gregory K. Thompson, Louisville, KY (US)

(73) Assignee: MANITOWOC FSG OPERATIONS, LLC.

(21) Appl. No.: 12/894,586

(22) Filed: Sep. 30, 2010

Related U.S. Application Data
(60) Provisional application No. 61/247,429, filed on Sep. 30, 2009.

(51) Int. Cl. B08B 3/00

(52) U.S. Cl. 134/22.1; 134/166 R

(57) ABSTRACT

A device for rinsing a container that dispenses a beverage includes the container that has a wall surrounding a volume that holds ingredients of the beverage and a magnet connected to the wall. A rinsing system includes a nozzle that sprays liquid and a switch that is attracted to the magnet so that when the magnet contacts the switch a rinse cycle is activated.

### CROSS-REFERENCE TO RELATED APPLICATIONS

This application claims the benefit of U.S. Provisional Application No. 61/247,429, filed Sep. 30, 2009. U.S. Provisional Application No. 61/247,429, filed Sep. 30, 2009 is hereby incorporated by reference in its entirety.

### BACKGROUND

1. Field

The present disclosure relates generally to mixing beverages. More particularly, the present disclosure relates to an apparatus and method for dispensing a predetermined amount of ingredients for a beverage into a container and rinsing the container.

2. Description of Related Art

Multiple steps are involved in creating a beverage or drink, for example, a smoothie drink, from beginning to end, and potential issues can occur at all stages. An employee must manually add an estimated amount to a blender pot or container. After the ice is manually added, the juice and any additional fruit or flavor “flavor ingredient” is added by the operator as well. Since the amount of ice and/or flavor ingredient is not measured, but rather “guesstimated” by each employee, the amount of ice and/or flavor ingredient is not precise and, therefore, makes it difficult to create the same beverage time after time.

Once the order is complete and the customer has his or her drink, there is one last step to finalize the process—the method of manually cleaning the container after each use to prevent the transfer of flavors and germs. Often, to save time, the blender containers are rinsed in a sink, which can compromise sanitation. While this might seem insignificant, flavor contamination can be a serious threat if customers have food allergies. Another drawback to the washing process is that it involves a substantial amount of time and labor on the part of the operator.

Accordingly, it has been determined by the present disclosure, there is a need for a system that increases accuracy of measuring one or more ingredients of a beverage to be mixed in a container. It has been further determined by the present disclosure, there is an additional need for an assembly for mixing a beverage that rinses and/or sanitizes the container.

### SUMMARY

A device for measuring an ingredient in a container of a beverage dispenser includes a scale having a base with the container supported on the base. The ingredient has a recipe weight equal to a weight of a total amount of the ingredient that will be dispensed into the container and an in-flight weight that is equal to a weight of the ingredient that has left the dispenser but is not yet supported within the container so that it is detected by the scale. A dispenser controller subtracts the in-flight weight parameter from the recipe weight to calculate a target weight of ingredient within the beverage container, thereby controlling the activation or deactivation of the ingredient dispenser(s).

A device for rinsing a container that dispenses a beverage comprising: the container comprising a bottom portion, a top portion and a wall disposed between the bottom portion and the top portion, wherein the top portion is open for receiving ingredients to produce a beverage, wherein the container further comprises a magnetic material disposed about the wall portion in proximity of the top portion; and a rinsing assembly comprising a support portion that receives the top portion of the container, a switch which activates and/or deactivates a rinse cycle within the rinsing assembly, and a nozzle disposed within the support portion that sprays liquid into the container when the rinse cycle is activated, wherein the switch is activated when the magnetic material is positioned within a predetermined proximity of the switch and deactivated when the magnetic material is removed from the predetermined proximity of the switch, and wherein the rinse cycle is initiated when the switch has been activated. When the switch activates the rinse cycle the nozzle sprays the liquid into the container, thereby removing the contents of the container.

The switch is preferably a reed switch.

The nozzle is positioned above the support portion, and wherein the support portion is connected to the switch.

The support portion has one or more protrusions positioned to be adjacent to the wall of the container securing the container on the support portion in a cleaning position, and wherein the nozzle is disposed within the interior of the container volume when in the cleaning position. The top portion of the container is disposed adjacent to the support portion when in the cleaning position.

The switch is disposed within the one or more protrusions of the support portion and the magnet material is disposed within the container so that the magnet magnetic material activates the switch when the container is in the cleaning position.

The one or more protrusions are positioned to secure the container in a first cleaning position and a second cleaning position on the support portion, and wherein the container has a different orientation in the first cleaning position than in the second cleaning position.

A method comprising: providing a container comprising a bottom portion, a top portion and a wall disposed between the bottom portion and the top portion, wherein the top portion is open for receiving ingredients to produce a beverage, wherein the container further comprises a magnetic material disposed about the wall portion in proximity of the top portion; and a rinsing assembly comprising a support portion that receives the top portion of the container, a switch which activates and/or deactivates a rinse cycle within the rinsing assembly, and a nozzle disposed within the support portion that sprays liquid into the container when the rinse cycle is activated; and detecting that the switch is activated when the magnetic material is positioned within a predetermined proximity of the switch and deactivated when the magnetic material is removed from the predetermined proximity of the switch; commencing the rinse cycle when the switch has been activated.

A device for rinsing a container that dispenses a beverage includes the container that has a wall surrounding a volume that holds ingredients of the beverage and a magnet connected to the wall. A rinsing system includes a nozzle that sprays liquid and a reed switch that is activated as it comes within a predetermined proximity of the magnet and deactivates as the magnet is moved away from the switch, such that a rinse cycle is activated when the magnet activates the reed switch.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a front plan view of an exemplary embodiment of a beverage mixing system according to the present disclosure;

FIG. 2 is an enlarged partial top front perspective view of a blending area and a rinse area of the beverage mixing system of FIG. 1;

FIG. 3 is side cross-sectional view of the rinse area of the beverage mixing system of FIG. 1;

FIG. 4 is an enlarged partial top front perspective view of the rinse area of the beverage mixing system of FIG. 1;

FIG. 5 is an enlarged partial top front perspective view of an area of the container having a magnet and an area of the rinse area having the switch;

FIGS. 6-7B are front side perspective views of the exemplary embodiment of the beverage mixing system according to the present disclosure;

FIG. 7C is a side view of the exemplary embodiment of the beverage mixing system according to the present disclosure;

FIG. 7D is a rear side perspective view of the exemplary embodiment of the beverage mixing system according to the present disclosure;

FIG. 7E is a front plan view of the exemplary embodiment of the beverage mixing system according to the present disclosure;

FIGS. 8A and 8B are a logic and flow diagram of a controller of the present disclosure;

FIG. 9 is a logic and flow diagram of a rinse controller of the present disclosure;

FIG. 10 is a block diagram of a controller of the beverage mixing system according to the present disclosure; and

FIG. 11 is an example of a wiring schematic that may be included in system 100 that may implement process 800 and/or process 900.

### DETAILED DESCRIPTION OF THE PREFERRED EMBODIMENT

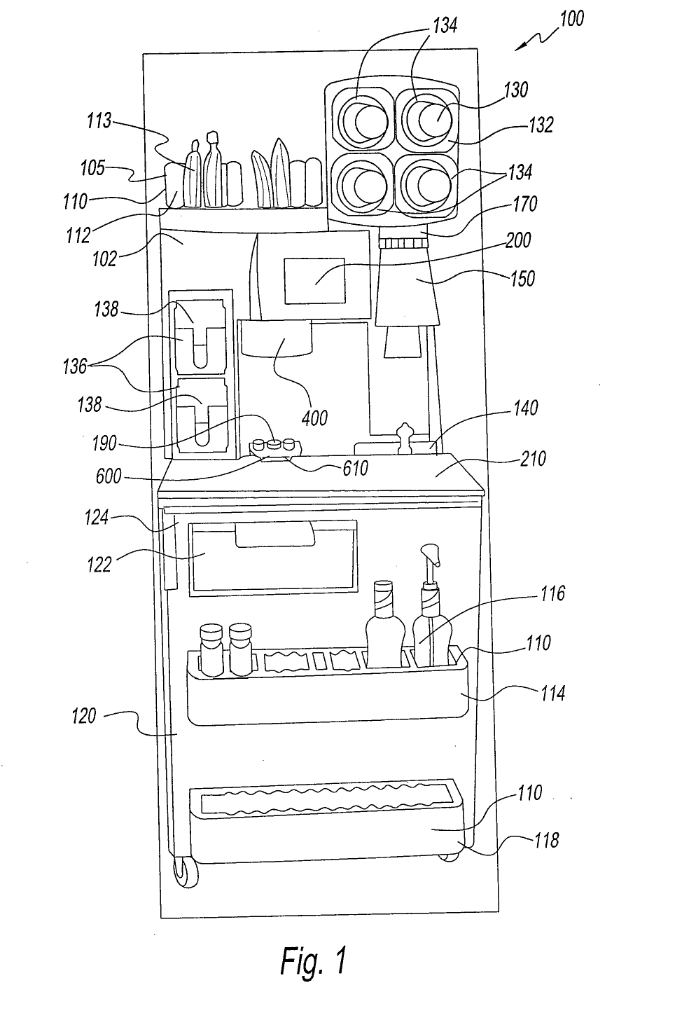

Referring to the drawings and in particular to FIG. 1, an exemplary embodiment of a beverage mixing system according to the present disclosure is generally referred to by reference numeral 100. System 100 mixes ingredients that may be stored thereon into a beverage. One such beverage, for example, is a smoothie that may include a flavor ingredient, for example, fruit or flavored syrup, and ice mixed together.

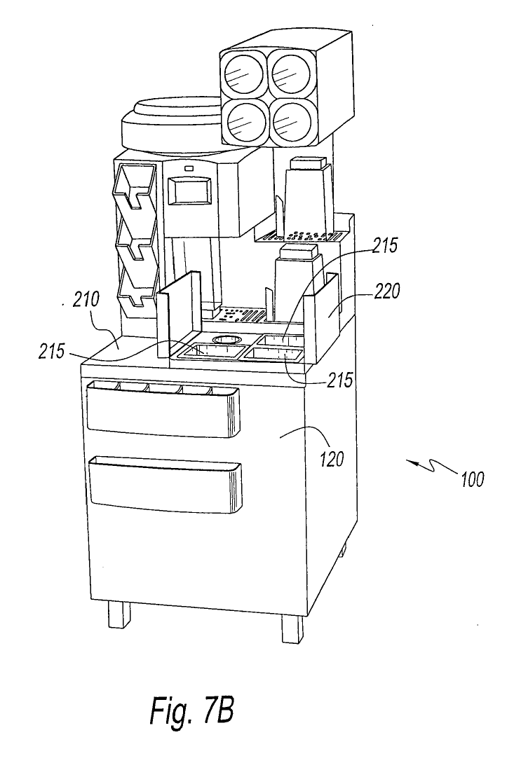

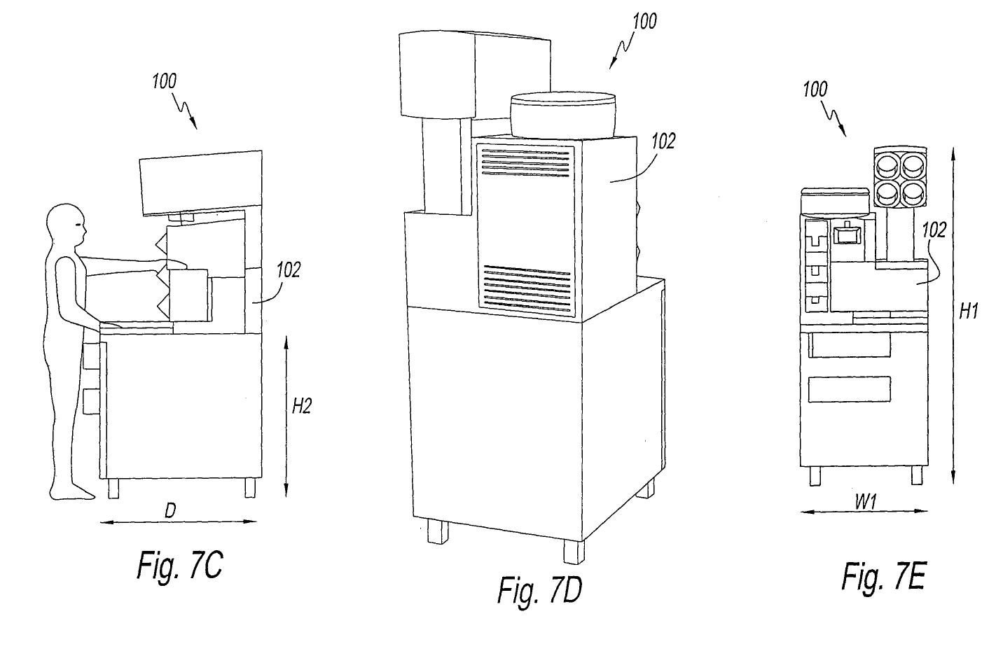

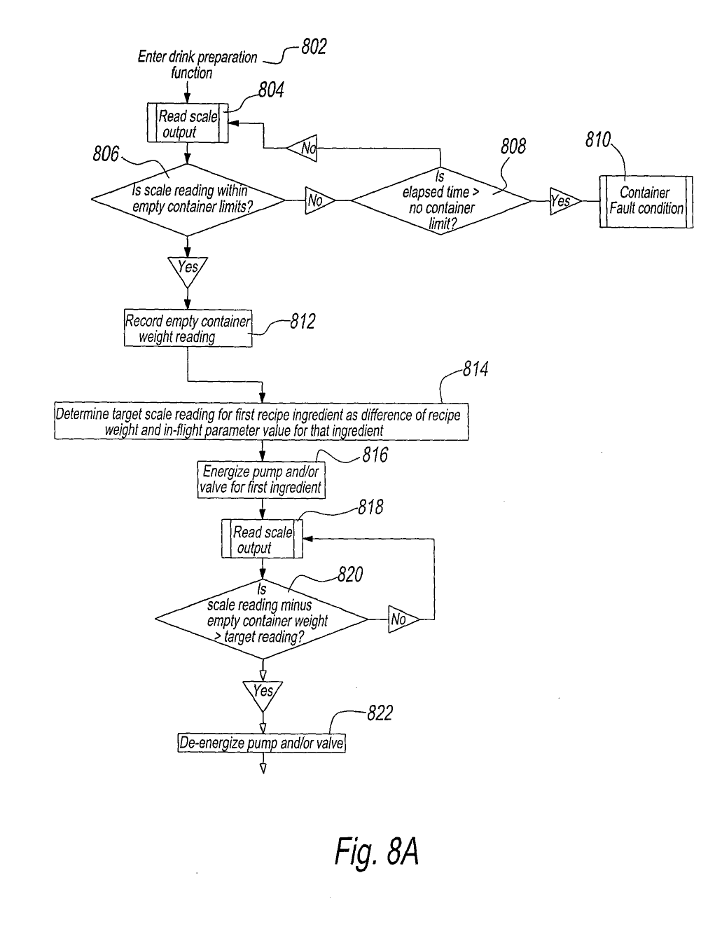

System 100 has a housing 102. As shown in FIGS. 7C-7D, housing 102 may have a depth D, for example of about 33 inches, a height H1, for example, of about 72 inches, a width W1, for example, of about 26 inches, and a counter height H2, for example, of about 33 inches. Housing 102 may have one or more shelves 110, as shown in FIG. 1. Shelves 110 include ingredients that are mixed to form the beverage. Shelves 110 include a shelf 112 that includes a shape having depressions sized to hold bananas 113. Shelves 110 include a shelf 114 that is partitioned to hold bottles of syrup or flavoring 116 that can be mixed with other ingredients, for example, ice or fruit, to form the beverage. Shelves 110 include a shelf 118 that stores banana peels that are discarded after bananas 113 are peeled and used for mixing a beverage.

Housing 102 may also include storage for cups 130 and/or lids that connect to cover an opening in cups 130. Cups 130 may be in a stacked configuration and removably inserted into cup dispenser 132. Cup dispenser 132 has one or more apertures 134 sized larger or equal to a largest dimension of cups 130, so that cups 130 are supported within apertures 134 via friction fit. Cup dispenser 132 may be spring loaded to urge cups 130 out of apertures 134 when one or more cups 134 are removed or on an incline so that cups are urged to apertures 134 by gravity. The lids may be stored in lid dispensers 136 that have an opening 138 to access the lids. The lids may be stacked and stored on an incline so that when one or more lids are removed the lids within lid dispensers 136 move toward opening 138.

System 100 has a user interface that may be a touch screen 200 connected to housing 102. Touch screen 200 allows a user to input, and/or the touch screen 200 may display, settings for temperature, time, and other parameters of system 100.

System 100 has an ice storage container 105 that maintains a predetermined temperature to store ice within housing 102. Ice storage container 105 may include an insulated volume, such as a “cooler”, or temperature controlled volume cooled by a cooling device, for example, a vapor compression cycle, for receiving and holding ice that may be selectively removed to mix a beverage. Ice storage container 105 is connected to a base 400 that has an ice dispensing assembly that dispenses ice through an ice aperture from ice storage container 105, for example, to a blending container 150. Ice within ice storage container 105 may contact a shaving wheel of the ice dispensing assembly, so that the ice is shaved into shaved particles, and the shaved particles are dispensed through the ice aperture in base 400 to the blending container 150.

System 100 has a refrigerated storage container 120 that maintains a predetermined temperature that is desirable for storing ingredients of the beverage that is mixed, for example, whip cream and/or fruit within housing 102. Refrigerated storage container 120 has an access door 122 that may be selectively opened and closed to retrieve the contents within refrigerated storage container 120. Access door 122 may provide access to ingredients only within the vicinity of the access door 122, and additional access may be provided to refrigerated storage container 120, for example, an entire front wall 124 may be selectively opened and closed to retrieve the contents within refrigerated storage container 120.

Refrigerated storage container 120 includes a refrigeration cycle, such as, for example, a vapor compression cycle that includes a compressor, condenser, expansion valve, and evaporator. One or more of the compressor, condenser, expansion valve, and evaporator may be integral with an ingredient dispensing assembly or remote from the rest of the ingredient dispensing assembly. For example, compressors may create undesirable noise and may be remotely located from the rest of the assembly.

The ingredient dispensing assembly has one or more holders that may each hold a container, such as, for example, a bag, that contains a flavor ingredient for the beverage. Refrigerated storage container 120 cools the one or more holders that may each hold the container. The flavor ingredient may be a flavored liquid or mix. The flavor ingredient is cooled while stored in refrigerated storage container 120. Each of the holders may have a connection aperture connected to a conduit of the ingredient dispensing assembly that passes from refrigerated storage container 120 to base 400. The conduit may connect to a pump of the ingredient dispensing assembly that selectively moves a portion of the ingredient from the container in the holders through the connection aperture, to the conduit, to a nozzle in base 400 to dispense the ingredient, for example, to blending container 150. The pump may be an air powered pump that may include a diaphragm. One or more holders may be a plurality of holders with an ingredient dispense tube for each ingredient in each of holders. The ingredient dispensing assembly and/or ice dispensing assembly may be controlled by a controller. The controller may be connected to housing 102 or remote from system 100, for example, a remote computer.

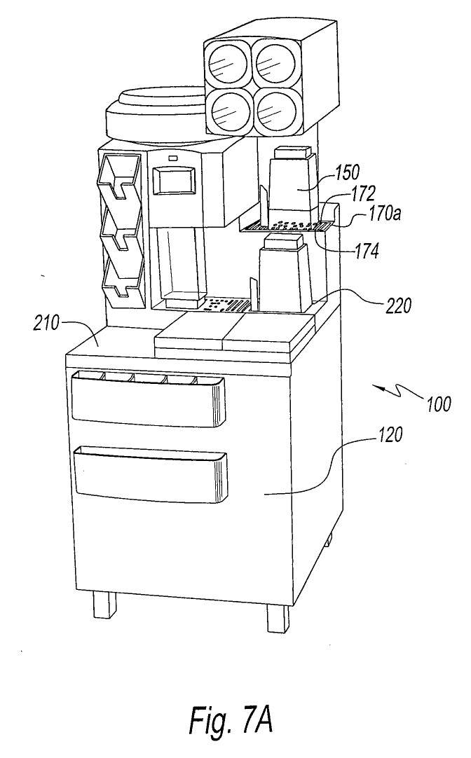

Blending container 150 is supported and held in position on a scale 600 when the flavor ingredient and/or ice is dispensed into blending container 150, as shown in FIG. 6. As shown in FIG. 1, scale 600 has a base plate 610 and pad that each are affixed on a first end of a cantilever beam that provides the only support for plate 610, the pad, and blending container 150 against the force of gravity. The cantilever beam is connected on a second end, opposite the first end, to a strain gauge that measures a deflection of the cantilever beam. Based on the known mechanical properties of the cantilever beam, a weight of blending container 150 is calculated and reported to the controller used to operate the ingredient dispensing assembly and/or ice dispensing assembly.

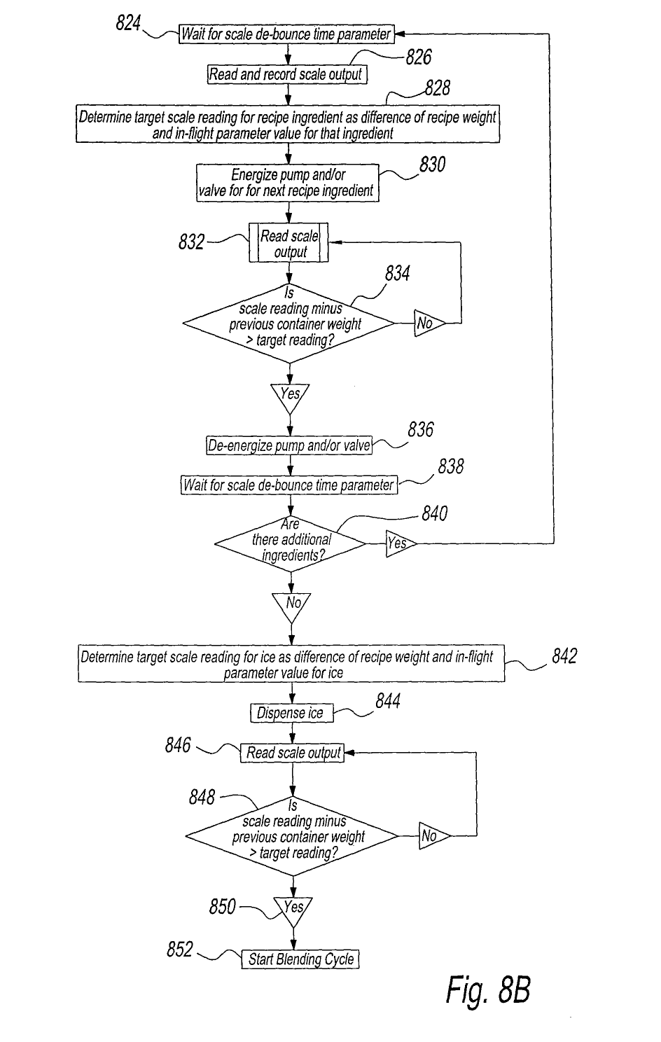

As shown in FIGS. 8A and 8B, the controller controls a process 800 to control an amount of ice and/or flavor ingredient dispensed into blending container 150. A user enters a drink preparation function in step 802. For example, a user selects a recipe that is stored in a memory, for example, the user selects a recipe via user interface 200, for a desired beverage. An output of scale 600 of a detected weight is read in step 804. It is determined whether the detected weight in step 804 is within a predetermined weight of an empty container limit in step 806. If the detected weight in step 804 is not within a predetermined weight of an empty container limit in step 806, it is determined if a predetermined amount of time has elapsed in step 808. If a predetermined amount of time has elapsed, a container fault condition is output in step 810, for example, a container fault condition outputs a signal displayed to the user on user interface 200. If a predetermined amount of time has not elapsed, steps 804 and 806 are repeated. If the detected weight in step 804 is within a predetermined weight of an empty container limit in step 806, an empty container weight reading from scale 600 is recorded in a memory in step 812. A recipe weight of an ingredient is equal to a target weight of a total amount of the ingredient, flavor ingredient or ice, is actually dispensed into the container and detected by the scale, and an in-flight weight that is equal to a weight of the ingredient that has left the dispenser, the flavor ingredient dispenser or ice dispenser, but is not yet disposed within the container for detection by the scale. The recipe weight and in-flight weight are each stored in the memory. A target weight that is equal to the in-flight weight subtracted from the recipe weight is calculated and stored in the memory in step 814. During operation, the controller sends an output signal to a solenoid or other valve to dispense selected ingredient(s), such that the ingredient(s) is dispensed from either flavor ingredient dispenser or ice dispenser into blending container 150 in step 816. While the ingredient is dispensed into blending container 150, a weight detected by scale 600 is read in step 818. The weight detected by scale 600 that is read in step 818 minus the empty container weight determined in step 806 is compared in step 820 to the target weight determined in step 814. If weight detected by scale 600 that is read in step 818 minus the empty container weight determined in step 806 is less than the target weight determined in step 814, steps 818 and 820 are repeated. If weight detected by scale 600 that is read in step 818 minus the empty container weight determined in step 806 is equal to or greater than the target weight determined in step 814, then controller sends an output signal to a solenoid or other valve to stop dispensing the ingredient, such that the ingredient(s) is no longer dispensed from either flavor ingredient dispenser or ice dispenser into blending container 150 in step 822 and process 800 may end.

The sample weight detected in step 818 taken by scale 600 may be a plurality of weights that are taken over a predetermined period of time that are averaged to calculate an average sample weight. The average sample weight may then be compared to the target weight. This moving average of the sample readings is used to filter noise introduced by harmonic vibration modes of the scale beam and base plate, and a time delay effect of the moving average filter is also compensated by the in-flight parameter value.

Once the ingredient is no longer dispensed because the target weight was reached, another ingredient may be dispensed according to steps 824-852 of process 800. A time delay, or scale de-bounce time parameter, equal to an in-flight time parameter that corresponds to the in-flight weight may be elapsed, in step 824, before a new value of a weight of blending container 150 with the first ingredient dispensed therein is recorded into the memory for use in dispensing another ingredient in step 826. A change in reaction force on blending container 150 resulting from the stop of flow of the first ingredient will introduce a vibration in the cantilever beam due to an excitation of a spring-mass system that includes blending container 150, the ingredient, base plate 610 and pad, and cantilever beam. The in-flight time parameter may allow this oscillation to decay sufficiently to obtain a stable and accurate reading for the new value of blending container weight in step 826. For example, the recipe weight may be between about 6.0 ounces to about 24 ounces with an in-flight weight parameter from about 0.5 ounces to about 4.0 ounces, and with the in-flight time parameter of about 0.2 seconds to 2 seconds.

A second recipe weight of a second ingredient is equal to a weight of a total amount of the second ingredient, flavor ingredient or ice, that will be dispensed into the container and a second in-flight weight that is equal to a weight of the second ingredient that has left the dispenser, the flavor ingredient dispenser or ice dispenser, but is not yet supported within container 150 to be detected by scale 600. The second recipe weight and the second in-flight weight are each stored in the memory. A second target weight that is equal to the second in-flight weight subtracted from the second recipe weight is calculated and stored in the memory in step 828. Thereafter, the controller sends an output signal to dispense the second ingredient(s), such that the second ingredient(s) is dispensed from either flavor ingredient dispenser or ice dispenser into blending container 150 in step 830. While the ingredient is dispensed into blending container 150, a weight detected by scale 600 is read in step 832. The weight detected by scale 600 that is read in step 832 minus the empty container weight determined in step 826 is compared in step 834 to the second target weight determined in step 828. If weight detected by scale 600 that is read in step 832 minus the empty container weight determined in step 826 is less than the second target weight determined in step 828, steps 832 and 834 are repeated. If weight detected by scale 600 that is read in step 832 minus the empty container weight determined in step 826 is equal to or greater than the second target weight determined in step 828, then the controller sends an output signal to stop the dispensing of the second ingredient, such that the second ingredient is no longer dispensed from either flavor ingredient dispenser or ice dispenser into blending container 150 in step 836 and process 800 may end.

A time delay, or scale de-bounce time parameter, equal to a second in-flight time parameter that corresponds to the second in-flight weight may be elapsed, in step 838. If it is determined in step 840 that there is an additional ingredient, or third ingredient, to be dispensed, steps 824-840 are repeated. If it is determined in step 840 that there is not an additional ingredient to be dispensed and ice is to be dispensed, an ice target scale reading for ice as a difference between an ice recipe weight and an ice in-flight parameter value is determined in step 842. Thereafter, the controller sends an output signal to dispense ice, such that ice is dispensed from ice dispenser into blending container 150 in step 844. While ice is dispensed into blending container 150, a weight detected by scale 600 is read in step 848. The weight detected by scale 600 that is read in step 848 minus the empty container weight that may be read after step 840 is compared in step 848 to the ice target weight determined in step 842. If weight detected by scale 600 that is read in step 846 minus the empty container weight is less than the ice target weight determined in step 842, steps 846 and 848 are repeated. If weight detected by scale 600 that is read in step 846 minus the empty container weight is equal to or greater than the ice target weight determined in step 842, then the controller sends an output signal to stop the ice dispensing, such that the ice is no longer dispensed from the ice dispenser into blending container 150 in after step 848 and process 800 may end or a blending cycle may begin in step 852.

When adding flavoring ingredients and shaved ice to a blending container, such as, blending container 150, placed on a scale, such as scale 600, a first reading from the scale at a first point in time does not represent an actual weight that would end up in the container if a flow of the ingredient were stopped at the first point in time due to effects of one or both of 1) a quantity of ingredient that has left the dispense nozzle, such as base 400, and has not reached blending container, such as blending container 150, so that the blending container supports the ingredient and is detected by the scale, and 2) a reaction force created from a momentum change of the ingredient flow as it strikes the blending container. Process 800 described herein anticipates the combined impact of a quantity of the ingredient that is airborne and a force-induced scale error to determine a more accurate scale reading to stop the ingredient from being dispensed and obtaining a desired quantity of the ingredient.

The in-flight weights may be determined or adjusted by comparing an actual weight to the recipe weight. The actual weight equals a difference between a weight following dispensing the ingredient into blending container 150 and a weight of blending container 150 without the ingredient therein that is stored in the memory. The in-flight weight may be determined or adjusted by subtracting the recipe weight from the actual weight.

Referring to FIG. 1, system 100 has a mixer 190. Mixer 190 may extend through an aperture in base plate 610 and container 150 when container 150 is in position on scale 600. Mixer 190 may be a spindle that rotates to mix flavor ingredients and ice within container 150. Mixer 190 may be controlled by a controller, for example, that rotates the spindle of mixer 190 a predetermined amount of time during the blending cycle. It may be undesirable to activate mixer 190 during process 800 due to forces mixer 190 may have on scale 600. The controller may prohibit the mixing cycle during process 800.

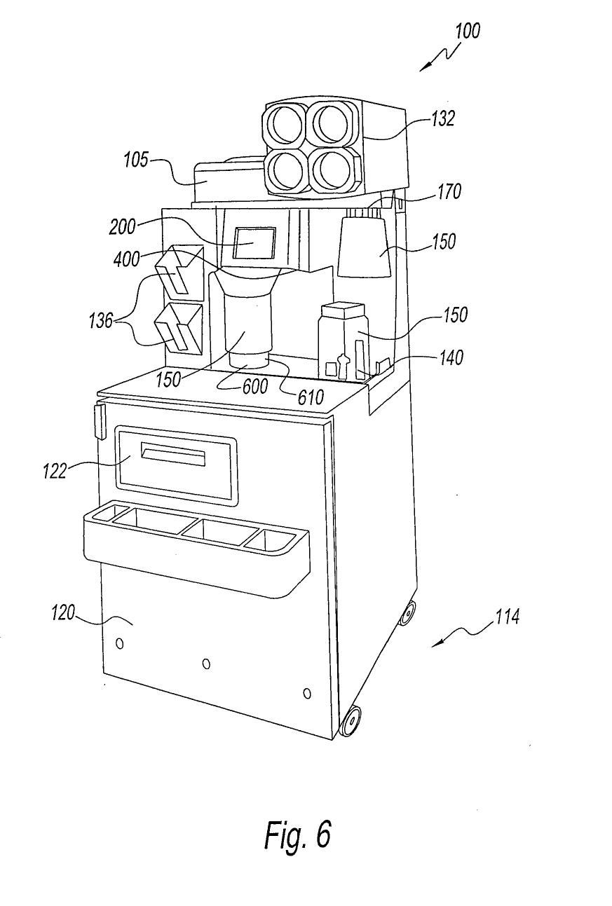

Now referring to FIGS. 1-5, system 100 has a rinse area 140. Rinse area 140 has a surface 141 connected to a water source by a conduit 142. Conduit 142 is connected to a nozzle 144 that sprays water and/or other cleaning liquid. Surface 141 has one or more drain apertures 146 that drain liquid from surface 141. Surface 141 may be connected to counter 210. Counter 210 provides a support portion, for example, for operators to dispense a beverage into one of cups 130 supported thereon. Referring to FIGS. 7A and 7B, counter may have one or more storage trays 215. Storage trays 215 may be in thermal communication with refrigerated storage container 120 so that storage trays 215 are cooled. Storage trays 215 may be within a cover 220 that can cover storage trays 215 in a closed position, as shown in FIG. 7A, and provide access to storage trays 215 in an open position, as shown in FIG. 7B.

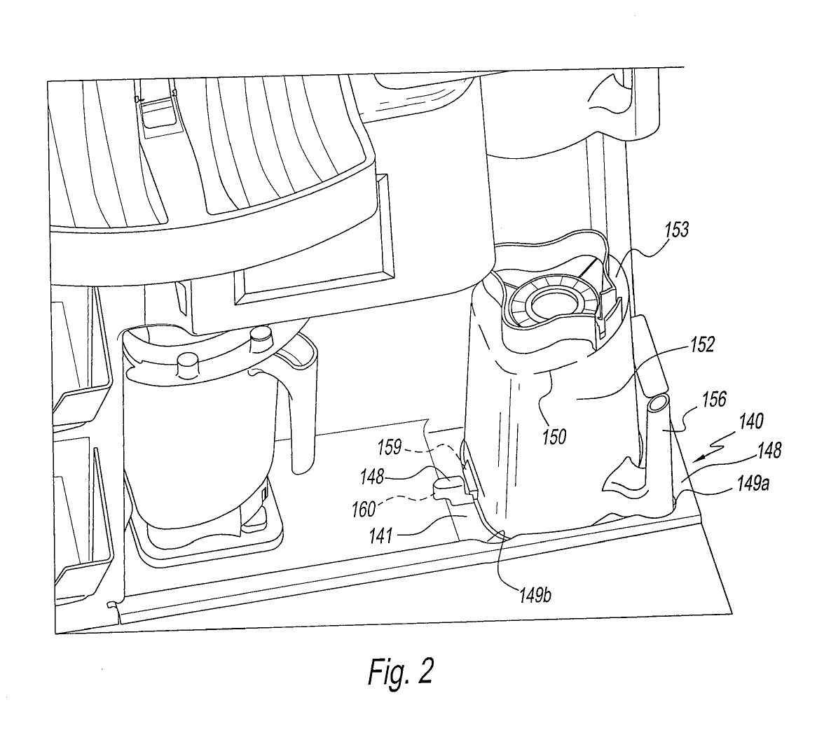

Surface 141 has one or more protrusions 148. Surface 141 has a switch 160 within one of protrusions 148. Switch 160 activates a rinse cycle. As shown in FIGS. 2-4, protrusions 148 are positioned so that container 150 fits within protrusions 148 at one or more predetermined orientations.

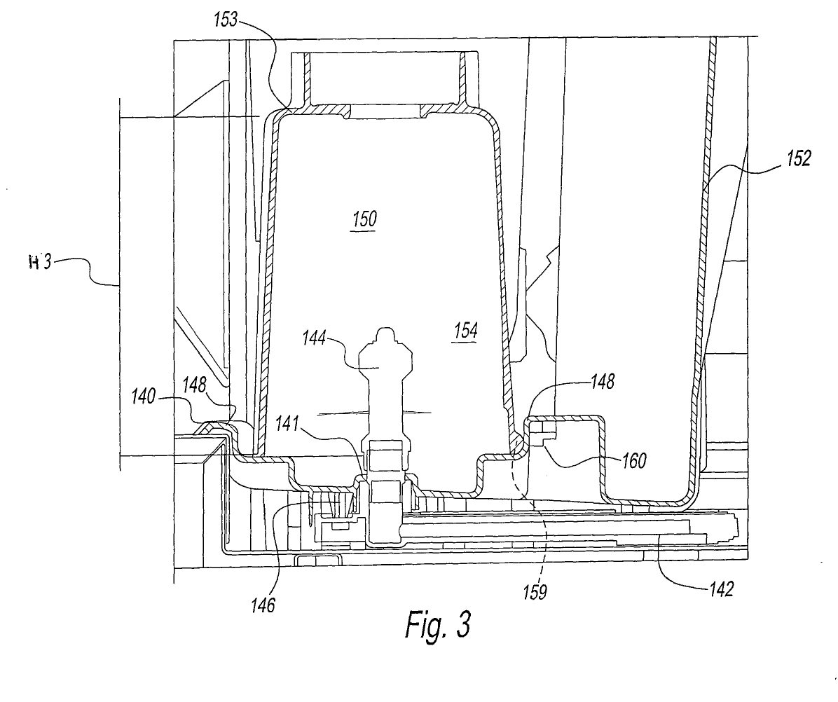

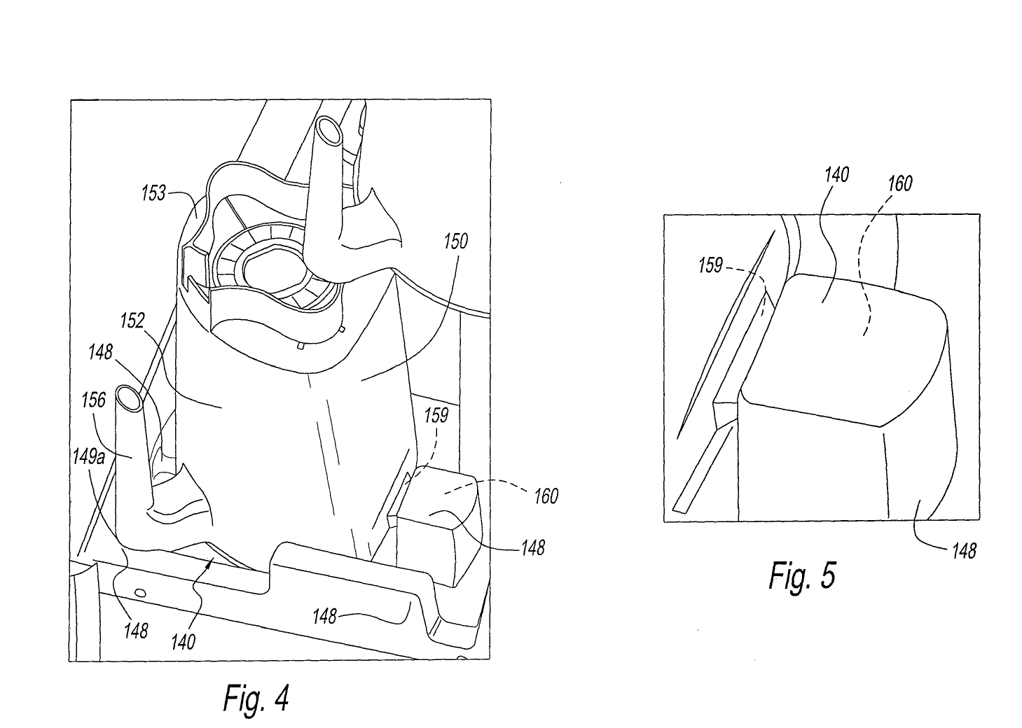

Container 150 has a sidewall 152 that surrounds a base wall 153 that encloses an inner volume 154, as shown in FIG. 3. Container 150 has at least a first magnet 159 connected thereto. Magnet 159 is connected to container 150 by being molded thereto. Magnet 159 may be connected to container 150, for example, by adhesive or any other connection. Container 150 may have a handle 156, as shown in FIGS. 2 and 4, connected to sidewall 152.

As shown in FIG. 2, container 150 fits within protrusions 148 in a first position so that handle 156 fits within a first depression 149a in one of protrusions 148 and sidewall 152 and base 153 are inverted to cover nozzle 144. A second depression 149b may be in one of protrusions 148 so that handle fits within second depression 149b to position container 150 in a second position, and sidewall 152 and base 153 are inverted to cover nozzle 144. When container is in the first position, magnet 159 is close enough to switch 160, so that magnet 159 may activate switch 160. In the second position, container 150 may have a second magnet attached thereto so that the second magnet is close enough to switch 160, so that the second magnet may activate switch 160. Alternatively, a second switch may be positioned within one of protrusions 148 so that magnet 159 is close enough to the second switch, so that magnet 159 may activate the second switch. The first position and second position reduce operator confusion and allows for both left and right hand location of container 150.

Switch 160 may have a bias device, for example, a spring, that biases switch 160 to a deactivated position when the magnet is moved away from switch 160. Magnet 159 activates or opens switch 160, as shown in FIG. 3, when blending container 150 is in the first position, and thereby activates the rinse cycle that is controlled by a rinse controller. During the rinse cycle, water and/or other cleaning liquid is sprayed through nozzle 144. A pressure of the water and/or other cleaning liquid is great enough to spray water and/or other cleaning liquid to at least a height H3 of base 153, as shown in FIG. 3, in the first position or second position of container 150. When magnet 159 is moved away from switch 160, as container 150 is removed from surface 141, switch 160 is deactivated or closed, thus stopping the rinse cycle.

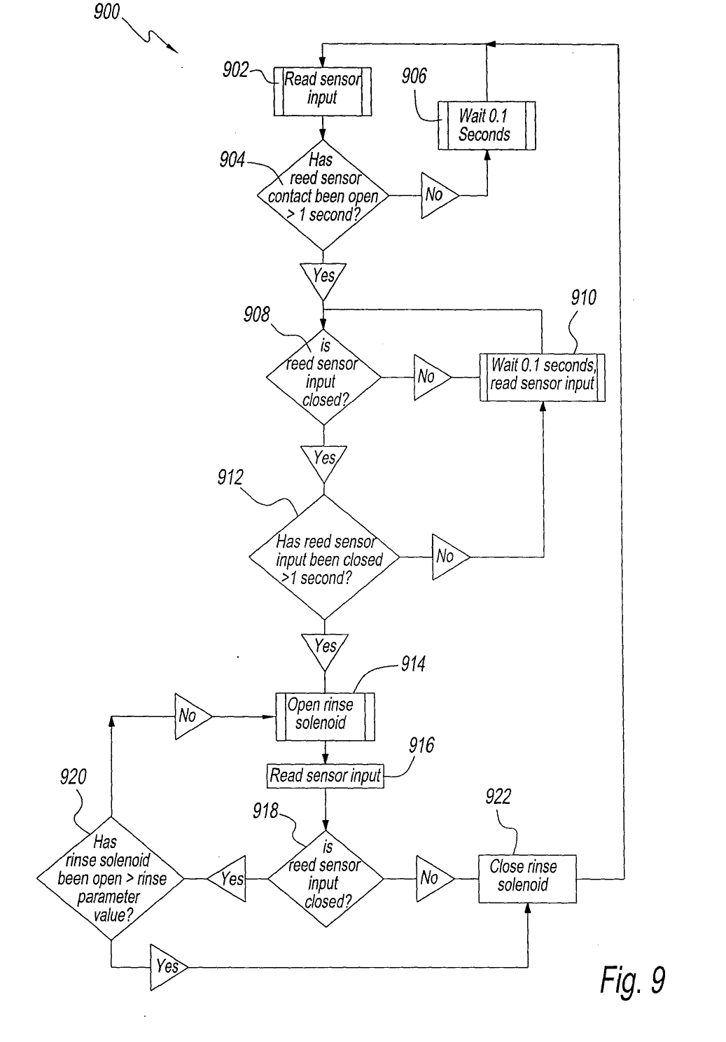

A process 900 for the rinse cycle may be controlled by a rinse process 900, as shown in FIG. 9. Switch 160 provides reed sensor input in step 902. Whether the reed sensor input indicates that the reed sensor contact is open, for example, if magnet 159 is within a predetermined proximity of switch 160 and wherein switch 160 is activated for greater than a predetermined time, such as about 1 second, is determined in step 904. If the reed sensor input indicates that that the reed sensor contact is open or activated for less than or equal to the predetermined time in step 904, a predetermined time is waited to elapse, for example about 0.1 second, in step 906, and steps 902 and 904 are repeated. If the reed sensor input indicates that that the reed sensor contact is open or activated for greater than the predetermined time in step 904, whether the reed sensor receives an input indicating that the reed sensor contact in switch 160 is closed or deactivated which is determined in step 908. If the reed sensor input indicates that that the reed sensor contact of switch 160 is not closed in step 908, a predetermined time is waited to elapse, for example, about 0.1 second, in step 910, and step 908 is repeated. If the reed sensor input indicates that that the reed sensor contact of switch 160 is closed in step 908, whether the reed sensor has been close for a greater time than a predetermined time, for example, about 1 second is determined in step 912. If the reed sensor has been close for less than or equal to the predetermined time in step 912, steps 910 and 908 are repeated. If the reed sensor has been close for greater than the predetermined time in step 912, a rinse cycle is commenced, for example, by opening a rinse solenoid valve in step 914. Switch 160 provides reed sensor input in step 916. Whether reed sensor input detected in step 916 indicates that that the reed sensor contact is closed is determined in step 918. If the reed sensor input indicates that that the reed sensor contact is closed in step 918, whether the reed sensor input indicates that that the reed sensor contact is closed greater than a rinse parameter value, for example a predetermined amount of time solenoid valve is open, is determined in step 920. If the reed sensor input indicates that that the reed sensor contact is closed less than or equal to the rinse parameter value in step 920, steps 916-920 are repeated. If the reed sensor input indicates that that the reed sensor contact is closed greater than the rinse parameter value in step 920, the rinse cycle is ended, for example, rinse solenoid is closed, and steps 902-922 are repeated.

System 100 may include a safety measure that requires magnet 159 and switch 160 to break contact prior to another rinse cycle commencing. This safety measure assures that the maximum of one rinse cycle will occur should switch 160 malfunction. For example, if the portion attracted to magnet 159 remains in the same position even when magnet 159 is removed, the safety measure will minimize the amount of water, sprayed from nozzle 144 in the absence of blending container 150, that can contact users and the surrounding environment.

Alternatively, one of protrusions 148 has an infrared projector and one of protrusions 148 has receiver that is activated by blending container 150 that has reflectors for returning a signal from the infrared projector to the infrared receiver to activate the rinse cycle. Another alternative includes a weigh beam scale connected to surface 141 that activates the rinse cycle when blending container 150 is placed on surface 141. A further alternative includes an infrared beam located above rinse area 140 that activates the rinse cycle if the beam is broken by blending container 150.

As shown in FIGS. 1, 6 and 7, housing 102 may have a container support 170 that removably connects to base 153 of blending container 150. Blending container 150 connects to container support 170 by base 150 so that inner volume 154 opens towards rinse area 140. After the rinse cycle, blending container 150 may be removably connected to container support 170 so that a portion of excess liquid that falls off of blending container 150 can drain through drain aperture 146. Alternatively, as shown in FIG. 7A, a container support 170A may be a shelf support 172 that has one or more apertures 174. After the rinse cycle, blending container 150 may be placed on container support 170A so that a portion of excess liquid that falls off of blending container 150 can drain through shelf support 172 that has one or more apertures 174.

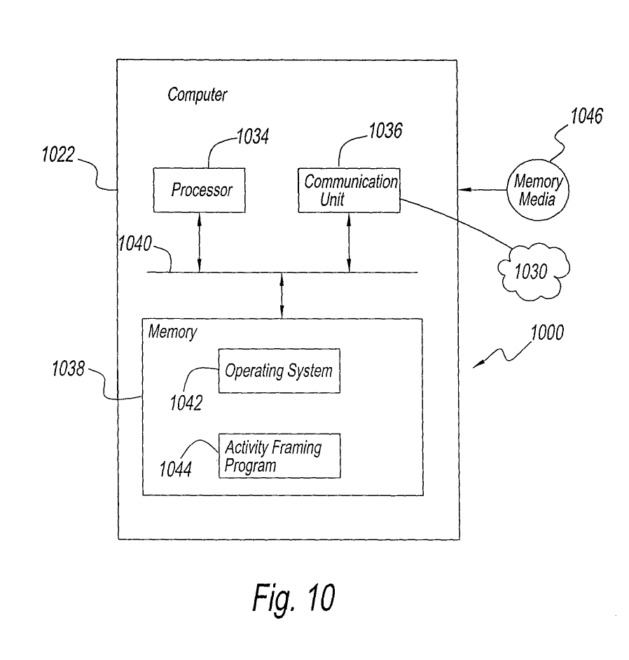

Referring to FIG. 10, computer 1022 includes a processor 1034, a communications unit 1036, a memory 1038 and a bus 1040. Bus 1040 interconnects processor 1034, communications unit 1036 and memory 1038. Memory 1038 includes an operating system 1042 and a program 1044. Operating system 1042 controls processor 1034 to execute program 1044 to operate system 100 for processes 800 and/or 900. A memory media 1046 (e.g., a disk) contains a copy of operating system 1042, program 1044 or other software, which can be loaded into memory 1038. Communications unit 1036 includes the capability to communicate via network 1030. Program 1044, when run, permits a user to operate system 100 to dispense ice and/or flavor ingredient and/or activate the rinse cycle.

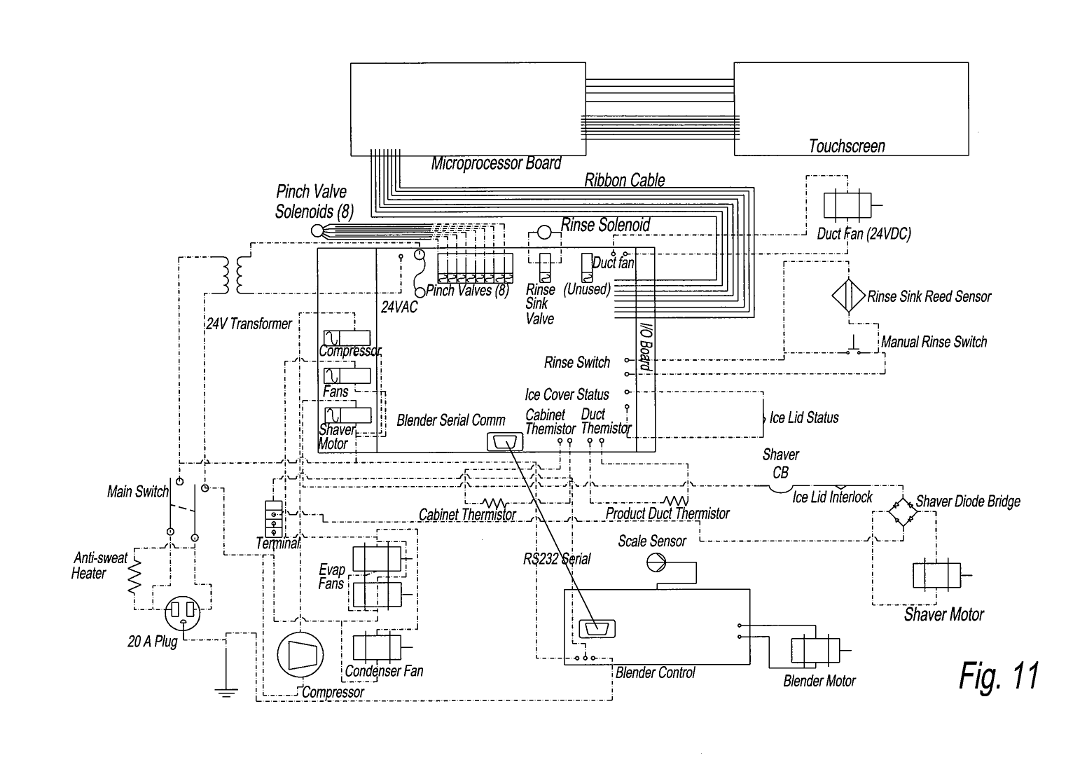

Referring to FIG. 11, an example of a wiring schematic that may be included in system 100 that may implement process 800 and/or process 900.

Devices may utilize mechanical linkages that contacts blending container 150 as it is placed in the rinse area to activate the rinse cycle. Mechanical linkages undesirably increase cost due to an amount of components included therein, can wear and tear pivot/hinge points of the mechanical linkages, lose parts during cleaning cycles, add a cleaning process for the linkage, and can cause occasional wet operators when they accidentally contact the linkage without a container located above the rinse nozzle. Further, mechanical linkages can protrude above a resting surface to contact the container for activation; the linkage accidentally can become activated by an object laying on the linkage and activating the rinse nozzle causing the surrounding area and possibly the operator to become wet. The magnet 159 and reed switch 160 eliminate any need for a mechanical linkage and associated problems therewith. Rinse area 140 contacts blending container 150 when it is in the first position or second position during the rinse cycle so that an area that may manage waste is touching a container which will be used to serve food after the rinse cycle. Since blending container 150 will service food after the rinse cycle, rinse area 140 may meet predetermined standards, such as, for example, National Sanitation Foundation fabrication criteria. Some requirements for the criteria may include surfaces are 100 grit or smoother, surfaces meet at an angle less than 135 degrees require an ⅛^{th} inch radius or otherwise the surface must be removed for cleaning and replaced without the use of tools, which is undesirable because cleaning cycle parts can be lost or installed incorrectly causing store operational issue and loss of revenue.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A device for rinsing a container that dispenses a beverage comprising:
the container comprising a bottom portion, a top portion and a wall disposed between said bottom portion and said top portion, wherein said top portion is open for receiving ingredients to produce a beverage, wherein said container further comprises a magnetic material disposed about said wall portion in proximity of said top portion; and
a rinsing assembly comprising a support portion that receives said top portion of said container, a switch which activates and/or deactivates a rinse cycle within said rinsing assembly, and a nozzle disposed within said support portion that sprays liquid into said container when said rinse cycle is activated,
wherein said switch is activated when said magnetic material is positioned within a predetermined proximity of said switch and deactivated when said magnetic material is removed from said predetermined proximity of said switch, and wherein said rinse cycle is initiated when said switch has been activated.

2. The device of claim 1, wherein when said switch activates said rinse cycle said nozzle sprays said liquid into said container, thereby removing the contents of said container.

3. The device of claim 1, wherein said switch is a reed switch.

4. The device of claim 1, wherein said nozzle is positioned above said support portion, and wherein said support portion is connected to said switch.

5. The device of claim 4, wherein said support portion has one or more protrusions positioned to be adjacent to said wall of the container securing the container on said support portion in a cleaning position, and wherein said nozzle is disposed within the interior of said container volume when in said cleaning position.

6. The device of claim 5, wherein said top portion of said container is disposed adjacent to said support portion when in said cleaning position.

7. The device of claim 5, wherein said switch is disposed within said one or more protrusions of said support portion and said magnet material is disposed within said container so that said magnet magnetic material activates said switch when the container is in the cleaning position.

8. The device of claim 5, wherein said one or more protrusions are positioned to secure the container in a first cleaning position and a second cleaning position on said support portion, and wherein the container has a different orientation in the first cleaning position than in the second cleaning position.

9. A method comprising:
providing a container comprising a bottom portion, a top portion and a wall disposed between said bottom portion and said top portion, wherein said top portion is open for receiving ingredients to produce a beverage, wherein said container further comprises a magnetic material disposed about said wall portion in proximity of said top portion; and a rinsing assembly comprising a support portion that receives said top portion of said container, a switch which activates and/or deactivates a rinse cycle within said rinsing assembly, and a nozzle disposed within said support portion that sprays liquid into said container when said rinse cycle is activated;
detecting that said switch is activated when said magnetic material is positioned within a predetermined proximity of said switch and deactivated when said magnetic material is removed from said predetermined proximity of said switch; and
commencing said rinse cycle when said switch has been activated.

10. The method of claim 9, further comprising the step of terminating said rinse cycle when said switch has been deactivated.

11. The method of claim 10, further comprising determining if said switch is in said deactivated position for greater than a predetermined deactivated time.

12. The method of claim 11, further comprising waiting a predetermined first wait time if said switch is in said deactivated position for less than said deactivated predetermined time.

13. The method of claim 12, further comprising waiting a predetermined second wait time if said switch is not detected to be in said activated position.

14. The method of claim 13 further comprising determining is said switch is in said activated position greater than a predetermined activated time.

15. The method of claim 14, wherein commencing said rinse cycle if said switch is in said activated position comprises commencing said rinse cycle if said switch is in said activated position greater than said predetermined activated time.

16. The method of claim 15, further comprising determining if said switch is in said activated position after said commencing of said rinse cycle.

17. The method of claim 16, further comprising determining if said switch has been in said activated position for greater than a predetermined rinse time after said commencing of said rinse cycle.

18. The method of claim 17, further comprising ending said rinse cycle if said switch has been in said activated position for greater than said predetermined rinse time.

19. The method of claim 17, further comprising ending said rinse cycle if it is determined that said switch is in said deactivated position after said commencing of said rinse cycle.
